(19) United States
(12) Patent Application Publication
(10) Pub. No.: US 2017/0062915 A1
(43) Pub. Date: Mar. 2, 2017

(54) ANTENNA DEVICE

(71) Applicant: KABUSHIKI KAISHA TOKAI RIKA DENKI SEISAKUSHO, Aichi (JP)

(72) Inventors: Takahiko ANDO, Aichi (JP); Masateru HURUTA, Aichi (JP); Shinji HASEGAWA, Aichi (JP)

(73) Assignee: KABUSHIKI KAISHA TOKAI RIKA DENKI SEISAKUSHO, Aichi (JP)

(21) Appl. No.: 15/239,161

(22) Filed: Aug. 17, 2016

(30) Foreign Application Priority Data
Aug. 26, 2015 (JP) 2015-166904

(51) Int. Cl. H01Q 1/32; H01Q 1/24; H01Q 1/50

(52) U.S. Cl. CPC H01Q 1/3291; H01Q 1/50; H01Q 1/24

(57) ABSTRACT

An antenna device includes a bar-shaped core, a bobbin into which the core is fitted, and a case that accommodates the bobbin and holds the core. The bobbin includes a resilient portion that bends and biases the core toward an inner side of the bobbin when interference occurs with an inner surface of the case. The resilient portion is configured to hold the core with friction force obtained when contacting the core and relieve impact force applied to the core while producing friction with the core.

### CROSS-REFERENCE TO RELATED APPLICATIONS

This application is based upon and claims the benefit of priority from prior Japanese Patent Application No. 2015-166904, filed on Aug. 26, 2015, the entire contents of which are incorporated herein by reference.

### BACKGROUND ART

The present invention relates to an antenna device includes a bar-shaped core.

Japanese Patent No. 4134173 describes an example of a low-frequency antenna device including a bar-shaped ferrite core.

A damper formed from silicone or rubber is attached to the ferrite core to increase the drop impact resistance of the ferrite core.

There is a need to increase the drop impact resistance of the ferrite core without using a damper so that costs can be reduced.

It is an object of the present invention to provide an antenna device that increases the drop impact resistance without using a damper.

### SUMMARY OF THE INVENTION

One aspect of the present invention is an antenna device including a bar-shaped core, a bobbin into which the core is fitted, and a case that accommodates the bobbin and holds the core. The bobbin includes a resilient portion that bends and biases the core toward an inner side of the bobbin when interference occurs with an inner surface of the case. The resilient portion is configured to hold the core with friction force produced when contacting the core, and the resilient portion is configured to relieve impact force applied to the core while producing friction with the core.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is an exploded perspective view schematically showing the structure of an antenna device;

FIG. 2 is a perspective view showing a core holding portion of a bobbin; and

FIG. 3 is a diagram illustrating the principle for holding a core.

### EMBODIMENTS OF THE INVENTION

One embodiment of an antenna device will now be described. The antenna device of the present invention is located in a passenger compartment of a vehicle and used for low frequencies. To establish bidirectional wireless communication between the vehicle and an electronic key, the vehicle transmits radio waves in the low frequency (LF) band. The radio waves trigger communication and form a smart communication area around the vehicle.

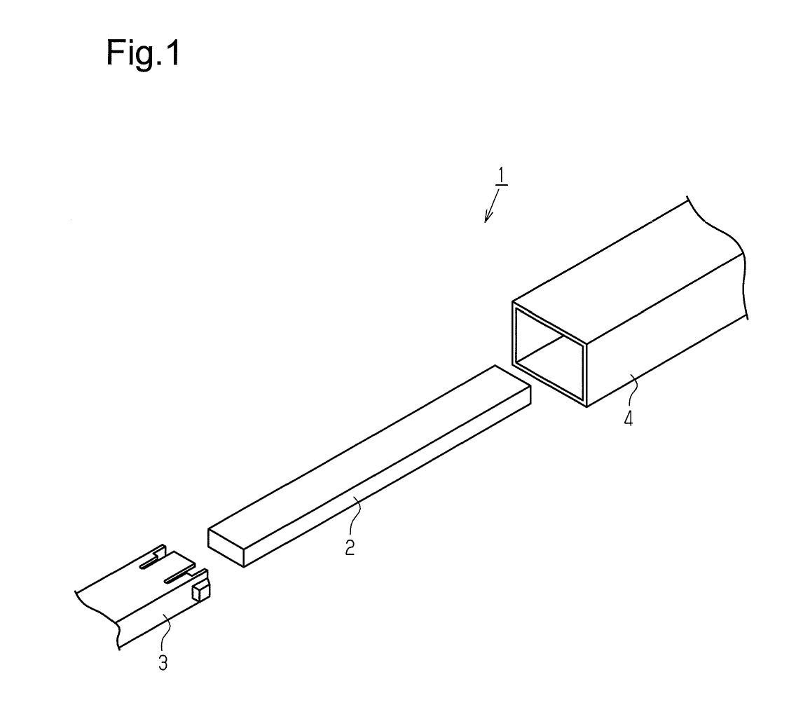

Referring to FIG. 1, in the antenna device 1, a bar-shaped core 2 is fitted into a bobbin 3, and the bobbin 3 is accommodated in a case 4. Thus, the core 2 is held in the case 4. The core 2, which is formed from a magnetic material such as ferrite, has a rectangular cross-sectional. The thickness of the core 2 is approximately one-half of the width of the core 2. The core 2 is longer than it is wide. The bobbin 3, which is formed from an insulative material, has a rectangular frame-like cross section. An antenna coil (not shown) is wound around a certain portion of the bobbin 3. The case 4, which is formed from an insulative resin, has a rectangular frame-like cross section that is larger than the bobbin 3.

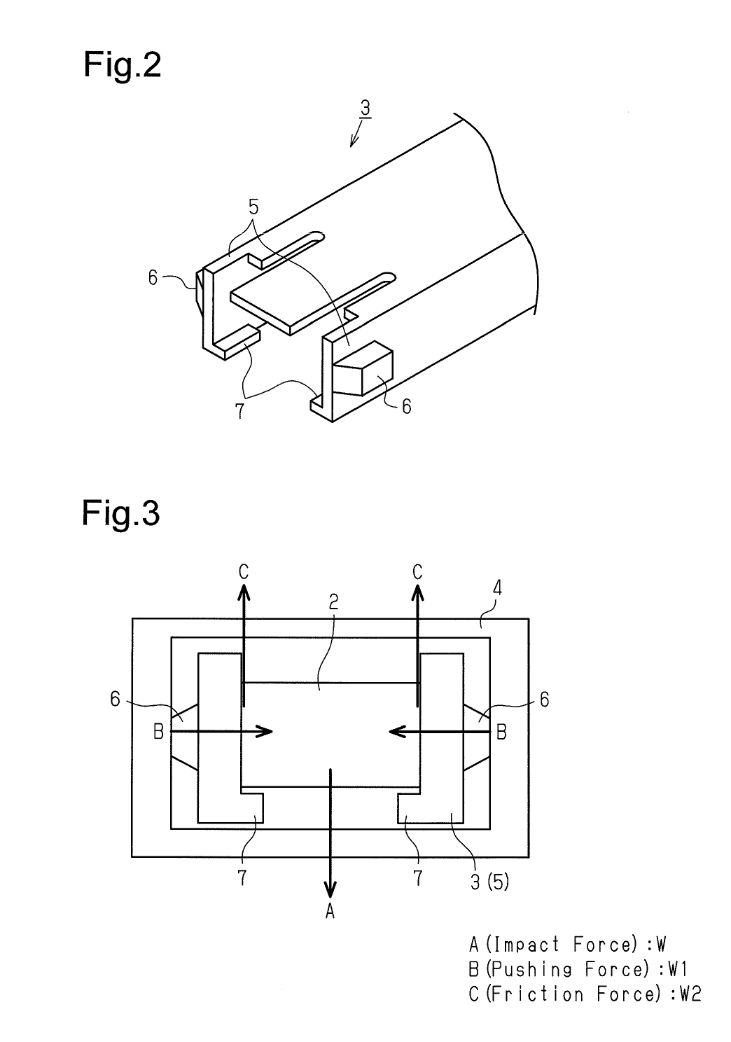

As shown in FIG. 2, the bobbin 3 includes an open end, an upper wall, a lower wall, and two side walls. The upper wall includes two slits extending from the open end near the two side walls. The lower wall includes an opening extending from the open end. In this structure, the two side walls each function as a resilient portion 5. The resilient portion 5 includes an outer projection 6 and an inner support 7. The bobbin 3 is fitted into the case 4 with each projection 6 in interference with the corresponding side wall. The distance between the outer end surfaces (interference surfaces) of the projections 6 before the bobbin 3 is fitted to the case 4 is set to be longer than the distance between the corresponding side walls of the case 4. The interference of the bobbin 3 with the case 4 bends and biases the two resilient portions 5 toward the inner side of the core 2. The two resilient portions 5 cooperate to produce friction force obtained by contacting the core 2 and hold the core 2 with the friction force. When the antenna device falls and an impact force exceeding the friction force is applied to the core 2, movement of the core 2 is permitted about the supports 7.

The operation of the antenna device 1 will now be described.

Referring to FIG. 3, the core 2 is fitted into the bobbin 3, and the bobbin 3 is fitted into the case 4. This results in interference of the projections 6 with the case 4 that bends and biases the resilient portions 5 toward the core 2. The biasing force acting toward the inner side of the case 4 in the direction indicated by arrow B is referred to as a pushing force W1. The pushing force W1 is adjusted by the amount of interference between the case 4 and the projections 6. The pushing force W1 acting between the core 2 and the bobbin 3 obtains a friction force W2 acting toward the upper side in the direction indicated by arrow C. The friction force W2 holds the core 2.

When the antenna device falls and an impact force W acting toward the lower side as indicated by arrow A exceeds the friction force W2, the friction force W2 holding the core 2 offsets a proportion of the impact force W. The difference between the impact force W and the friction force W2 produces a force (W-W2) that moves the core 2 about the supports 7 while producing friction with the bobbin 3. This consumes a proportion of the impact force W as kinetic energy. In this manner, the resilient portions 5 relieve the impact force W and reduce the impact force W that is applied to the core 2.

The present embodiment has the advantages described below.

(1) The resilient portions 5 of the bobbin 3 hold the core 2. When the antenna device falls and impact force is applied to the core 2, friction produced between the core 2 and the resilient portions 5 relieves the impact force. This avoids damage to the core 2 that would be caused by the impact produced when the antenna device falls. Further, there is no need for a separate component such as a damper to be attached to the core 2. Thus, the drop impact resistance can be increased without using a damper.

(2) The resilient portions 5 permit movement of the core 2 while producing friction with the core 2. This relieves the impact force applied to the core 2. In this structure, a proportion of the impact force is consumed as kinetic energy of the core 2. This reduces the impact force and increases the drop impact resistance.

(3) The resilient portions 5 allow the force resulting from the difference of the impact force W, which exceeds the friction force W2, and the friction force W2 to move the core 2. In this structure, the core 2 moves after the friction force W2 holding the core 2 offsets a proportion of the impact force W. This reduces the acceleration of the core 2 and avoids damage to the core 2.

It should be apparent to those skilled in the art that the present invention may be embodied in many other specific forms without departing from the spirit or scope of the invention. Particularly, it should be understood that the present invention may be embodied in the following forms.

Instead of using the core 2 that has the form of a polygonal bar, a core having the form of a round bar may be used. In this case, the surface of each resilient portion 5 is curved to obtain the desired friction force when contacting the core. When the antenna device falls, the impact applied to the core allows the core to rotate while producing friction with the resilient portions 5. A proportion of the impact force is consumed as kinetic energy of the rotation.

The antenna device according to the present invention is not limited to an LF antenna device used for smart communication.

The present examples and embodiments are to be considered as illustrative and not restrictive, and the invention is not to be limited to the details given herein, but may be modified within the scope and equivalence of the appended claims.

1. An antenna device comprising:
a bar-shaped core;
a bobbin into which the core is fitted; and
a case that accommodates the bobbin and holds the core; wherein
the bobbin includes a resilient portion that bends and biases the core toward an inner side of the bobbin when interference occurs with an inner surface of the case,
the resilient portion is configured to hold the core with friction force produced when contacting the core, and
the resilient portion is configured to relieve impact force applied to the core while producing friction with the core.

2. The antenna device according to claim 1, wherein the resilient portion is configured to relieve the impact force by permitting movement of the core while producing friction with the core.

3. The antenna device according to claim 2, wherein the resilient portion is configured to move the core with a force obtained from a difference of an impact force, which exceeds the friction force, and the friction force.

4. The antenna device according to claim 1, wherein
the resilient portion is one of two resilient portions,
the two resilient portions are defined by two opposing portions of the bobbin, and
the two resilient portions hold the core.
